(19) United States
(12) Patent Application Publication
(10) Pub. No.: US 2011/0053389 A1
(43) Pub. Date: Mar. 3, 2011

(54) GROUND CONNECTOR FOR PORTABLE ELECTRONIC DEVICE

(75) Inventors: MING-ZHI ZHENG, Shenzhen (CN); JI ZHOU, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/774,066

(22) Filed: May 5, 2010

(30) Foreign Application Priority Data
Aug. 26, 2009 (CN) 200910306119.0

(51) Int. Cl. H01R 12/14; H01R 13/02

(52) U.S. Cl. 439/66; 439/884

(57) ABSTRACT

A portable electronic device includes two PCBs and a ground connector. The ground connector includes a flat, two legs, and an arm. The flat attaches the grounding connector to one of the PCBs. The two legs project from the flat and cooperatively defining a receiving space. The arm, extending from the flat, is received and extends of the receiving space and electronically connecting to the other PCB.

### BACKGROUND

1. Technical Field

The present disclosure relates to ground connectors and, particularly, to a ground connector used in a portable electronic device.

2. Description of Related Art

Electronic devices usually include a plurality of electrical components to realize different functions. In order to prevent electrostatic charges from damaging the electrical components, a grounding mechanism is usually provided for removal of electromagnetic interference and electrostatic charges.

However, a conventional grounding structure is usually fixed between two printed circuit boards (PCBs) in an electronic device. If the device should suffer an impact, damaging contact may occur between the PCBs and grounding structure.

Therefore, there is room for improvement within the art.

### BRIEF DESCRIPTION OF THE DRAWINGS

Many aspects of the exemplary ground connector can be better understood with reference to the following drawings. The components in the drawings are not necessarily drawn to scale, the emphasis instead being placed upon clearly illustrating the principles of the portable electronic device utilizing the ground connector. Moreover, in the drawings, like reference numerals designate corresponding parts throughout the several views, in which:

FIG. 1 is an isometric view of an exemplary embodiment of a grounding connector of a portable electronic device;

FIG. 2 is similar to FIG. 1, but viewed from another aspect;

FIG. 3 is a cross-sectional view of a portable electronic device, showing the ground connector of FIG. 1 along line III-III;

FIG. 4 is similar to FIG. 3, but showing the grounding connector in a deformed state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

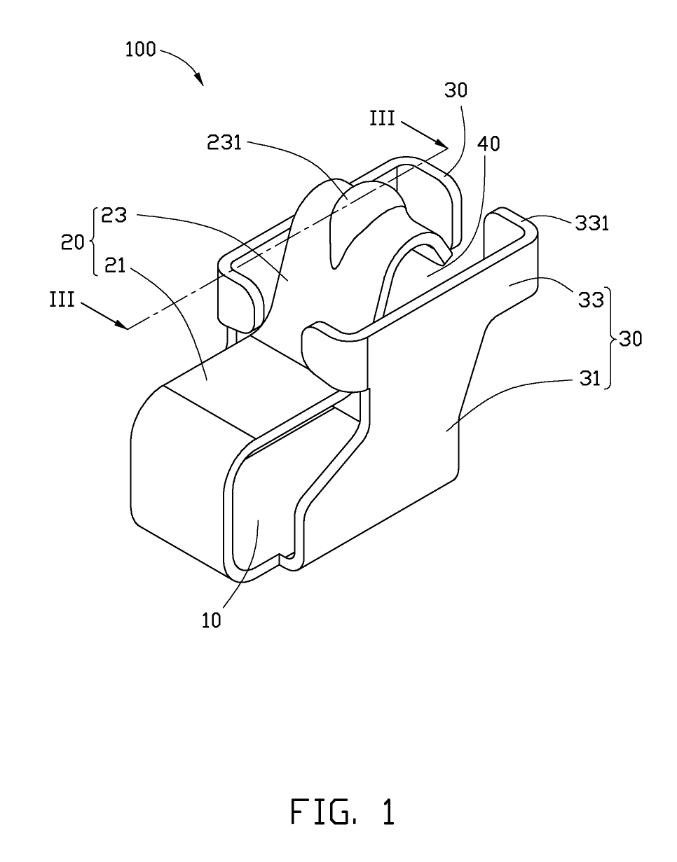

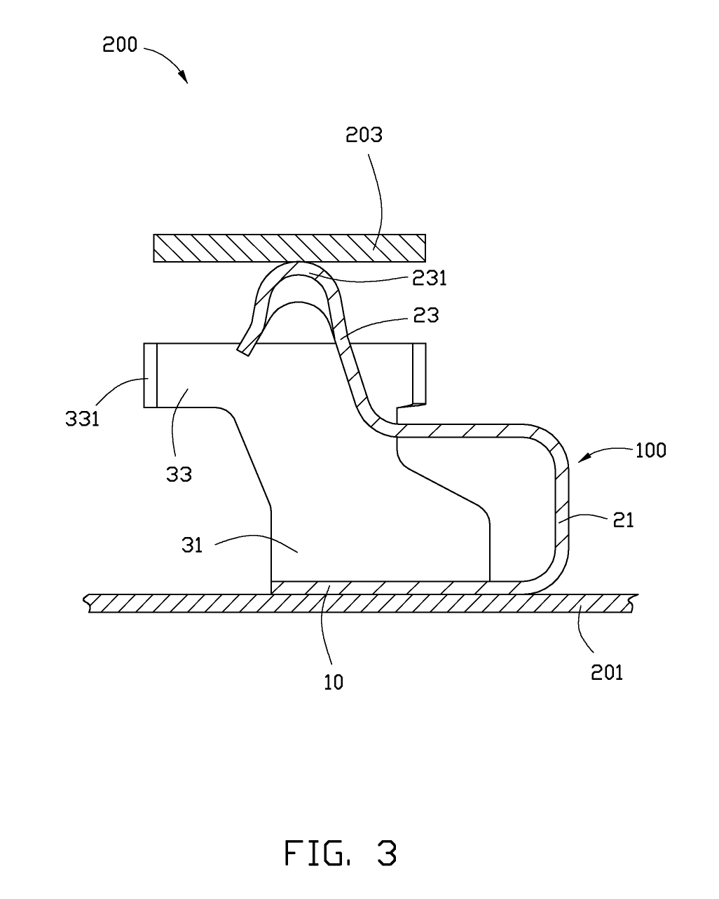

FIG. 1 is an isometric view of an exemplary embodiment of a ground connector 100 for use in a portable electronic device 200 (shown in FIG. 3), such as a cellular phone, game player, PDA (personal digital assistant) and so on. The ground connector 100 is made of metal, and is integrally formed, e.g., by stamping or punching from a metal sheet. The ground connector 100 includes a flat portion 10, an arm 20, and two legs 30. The arm 20 serpentinely extends from one edge of the flat portion 10. The two legs 30 substantially perpendicularly project from two opposite sides of the flat portion 10. A receiving space 40 is defined between the two legs 30, in which the arm 20 is received. A highest point of the arm 20 is higher than that of the two legs 20 when the ground connector is in an uncompressed state.

The arm 20 includes a connecting portion 21 and a contacting portion 23. The connecting portion 21 perpendicularly extends from one edge of the flat portion 10, and then extends parallels to the flat portion 10. The contacting portion 23 extends first upwards from one end of the connecting portion 21 and then towards the flat portion 10 such that the contacting portion 23 is generally arcuate. A protrusion 231 projects from the contacting portion 23 forming a peak of the contacting portion 23.

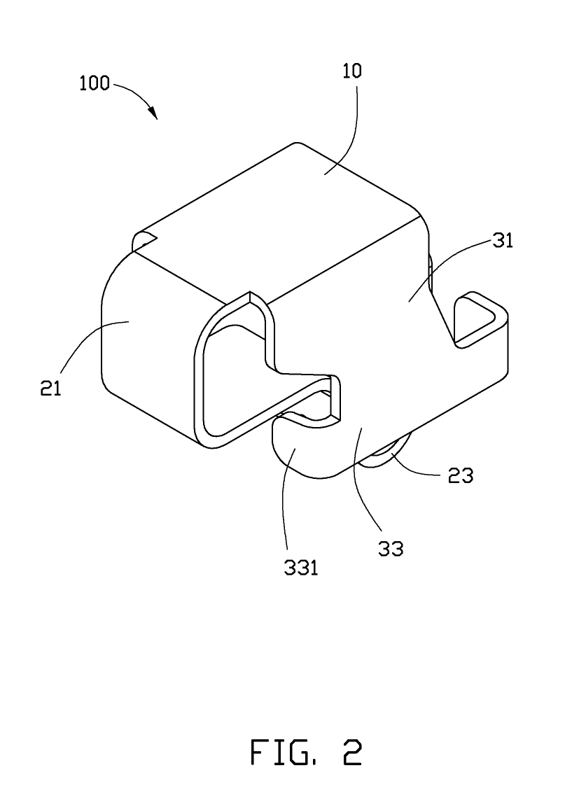

Referring also to FIG. 2, each les 30 includes a supporting portion 31 and a resisting portion 33. The supporting portion 31 projects substantially perpendicularly from one side of the flat portion 10. A tab 331 projects perpendicularly from each end of the resisting portion 33. The two tabs 331 at the same side face each other.

Referring to FIG. 3, the device 200 further includes a first PCB 201 and a second PCB 203. The grounding connector 100 is positioned between the first PCB 201 and the second component 203 and configured for electrically connecting the first PCB 201 to the second PCB 203. In the exemplary embodiment, the first and second PCBs 201 and 203 may be, for example, a circuit of a keyboard of the device 200 and an underlying main printed wiring board (PWB).

During assembly, the first PCB 201 is secured by a suitable fastener (not illustrated), such as a bolt, to the device 200. The flat portion 10 of the grounding connector 100 is fixed to the first PCB 201 by another fastener (not illustrated), heat-melting, or welding. The second PCB 203 is secured by another suitable fastener (not illustrated) with a predetermined spacing between the two PCBs 201 and 203. The spacing is generally equal to the uncompressed height of the grounding connector 100 such that the two PCBs 201 and 203 electronically connect to each other and the resisting portions 33 are distant from the second PCB 203.

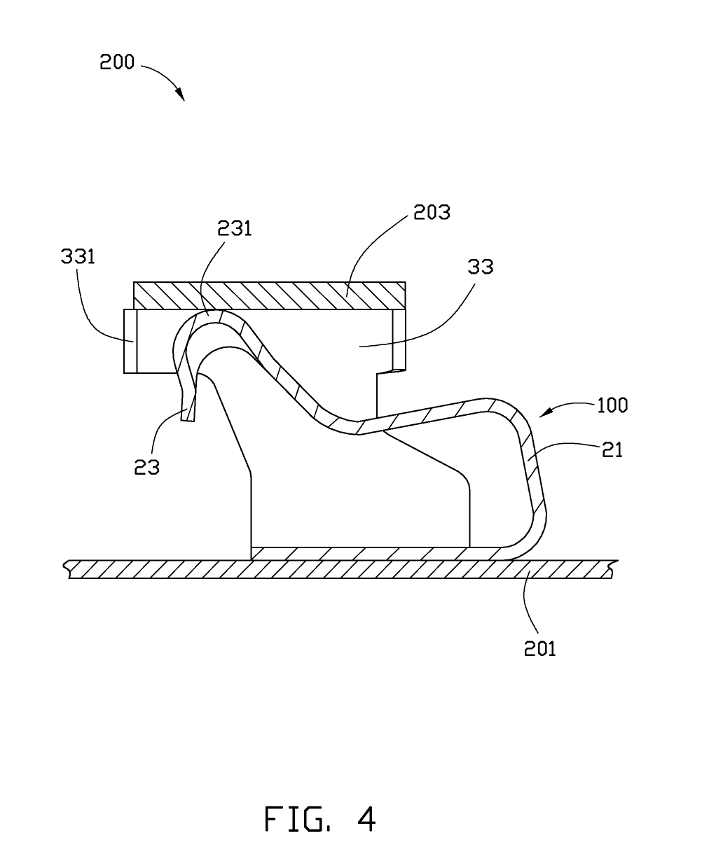

Referring to FIG. 4, if an impact on the device 200 causes the second PCB 203 to move towards the first PCB 201, the contacting portion 23 is elastically compressed. This absorbs at least some of the energy of the impact. The supporting portions 31 of legs 30 resist against the second PCB 203 and act as limiters to maintain a predetermined standoff between the PCBs 201 and 203. Thus the grounding connector 100 provides a simple, one-piece device for protecting the PCBs 201 and 203 by limiting deflection of the PCBs 201 and 203.

It is to be understood that more than one grounding connector 100 can be provided if desired. The spacing between the first PCB 201 and the second PCB 203 can be larger than the uncompressed height of the grounding connector 100 such that the grounding connector 100 can act as an elastic ejecting device configured for e.g., a button so that the two PCBs 201 and 203 are electronically connected to each other by the grounding connector 100 when desired.

It is believed that the present embodiments and their advantages will be understood from the foregoing description, and it will be apparent that various changes may be made thereto without departing from the spirit and scope of the disclose or sacrificing all of its material advantages, the examples hereinbefore described merely being preferred or exemplary embodiments of the disclosure.

What is claimed is:

1. A grounding connector for mounting between two printed circuit boards comprising:
a flat portion configured for attaching the grounding connector to one of the printed circuit boards;
two legs projecting from the flat portion and defining a receiving space;
an arm extending from the flat portion, the arm received in and extending out of the receiving space, configured for electronically connecting to the other printed circuit board.

2. The grounding connector as claimed in claim 1, wherein the arm includes a connecting portion and a contacting portion, the connecting portion extends from the flat portion and reaches into the receiving space, the contacting portion serpentinely extends from the contacting portion with a peak extending out of the receiving space.

3. The grounding connector as claimed in claim 2, wherein the contacting portion is V-shaped.

4. The grounding connector as claimed in claim 2, wherein a protrusion projects from the contacting portion, the contacting portion electrically connected to one of the printed circuit boards.

5. The grounding connector as claimed in claim 1, wherein each of the legs comprises a supporting portion projecting from the flat portion and a resisting portion for resisting the printed circuit boards when the grounding connector in a compressed state.

6. The grounding connector as claimed in claim 6, wherein a tab projects from each of the resisting portions, the tabs at the same side face each other.

7. A portable electronic device comprising:
a first printed circuit board;
a second printed circuit board; and
a ground connector comprising:
a flat portion attaching to the first printed circuit board;
two legs projecting from the flat portion;
an arm extending from the flat portion, the arm forming a contacting portion electronically connected to the other printed circuit board, and the legs supporting the second printed circuit board when the contacting portion is deformed.

8. The portable electronic device as claimed in claim 7, wherein the arm includes a connecting portion and a contacting portion, the connecting portion serpentinely extends from the flat and reaches into the receiving space, the contacting portion serpentinely extends from the contacting portion with a peak extending out of the receiving space.

9. The portable electronic device as claimed in claim 8, wherein the contacting portion is V-shaped.

10. The portable electronic device as claimed in claim 8, wherein a protrusion projects from the contacting portion, the contacting portion electrically connected to one of the printed circuit boards.

11. The portable electronic device as claimed in claim 7, wherein the legs each comprise a supporting portion projecting from the flat portion and a resisting portion for resisting the printed circuit boards when the grounding connector in a compressed state.

12. The portable electronic device r as claimed in claim 7, wherein a tab projects from each of the resisting portions, the tabs at the same side face each other.

13. A portable electronic device comprising:
two PCBs positioned with a predetermined spacing;
a flat portion attaching the grounding connector to one of the printed circuit boards;
two legs projecting from the flat portion and defining a receiving space;
an arm extending from the flat portion, received in and extending out of the receiving space, electronically connecting to the other printed circuit boards, a height of the arm larger or equal to the spacing between the two PCBs.

14. The portable electronic device as claimed in claim 13, wherein the arm includes a connecting portion and a contacting portion, the connecting portion serpentinely extends from the flat portion and reaches into the receiving space, the contacting portion serpentinely extends from the contacting portion with a peak extending out of the receiving space.

15. The portable electronic device as claimed in claim 14, wherein the contacting portion is V-shaped.

16. The portable electronic device as claimed in claim 14, wherein a protrusion projects from the contacting portion, the contacting portion electrically connected to one of the printed circuit boards.

17. The portable electronic device as claimed in claim 13, wherein the legs each comprise a supporting portion projecting from the flat portion and a resisting portion for resisting the PCBs when the grounding connector in a compressed state.

18. The portable electronic device as claimed in claim 13, wherein a tab projects from each of the resisting portions, the tabs at the same side face each other.
